(19) United States
(12) Patent Application Publication
(10) Pub. No.: US 2022/0127730 A1
(43) Pub. Date: Apr. 28, 2022

(54) Corrosion Control Treatment Program

(71) Applicant: Ecolab USA Inc., St. Paul, MN (US)

(72) Inventors: Bingzhi Chen, Naperville, IL (US); Malgorzata A. Krawczyk, Chicago, IL (US); Craig W. S. Myers, Lisle, IL (US); John M. Chudomel, Aurora, IL (US); Pradeep Cheruku, Bolingbrook, IL (US)

(73) Assignee: Ecolab USA Inc., St. Paul, MN (US)

(21) Appl. No.: 17/495,978

(22) Filed: Oct. 7, 2021

Related U.S. Application Data
(60) Provisional application No. 63/089,057, filed on Oct. 8, 2020.

(51) Int. Cl. C23F 11/18; C23F 11/12

(52) U.S. Cl. CPC C23F 11/18; C23F 11/126

(57) ABSTRACT

The invention provides a water treatment composition comprising a cathodic inhibitor comprising at least one rare earth metal, an anodic inhibitor comprising at least one polycarboxylic acid, and a polymer dispersant comprising at least one sulfonic group. The invention also provides a method of inhibiting corrosion of a metal in an industrial water system, which method includes treating water of the industrial water system with the composition of the invention, to provide treated water.

### CROSS-REFERENCE TO RELATED APPLICATIONS

This patent application claims the benefit of U.S. Provisional Patent Application No. 63/089,057, filed Oct. 8, 2020, the disclosure of which is incorporated herein by reference for all purposes.

### BACKGROUND OF THE INVENTION

The increasing concern for protecting the environment, and more particularly the global waterways, has necessitated a change in the way we think about industrial water systems. Conventionally, industrial water systems (e.g., open loop cooling systems) have required chemical treatment programs heavy in zinc and/or phosphorous to help reduce the corrosion of the metals (e.g., mild steel) used to operate the industrial water system. Unfortunately, these chemical treatment programs get discharged into waterways, thereby polluting the environment. Thus, chemical treatment programs that exclude zinc and phosphorus are highly desirable.

However, in order to successfully control the corrosion of a metal in an industrial water system, certain corrosion standards must be met. For example, successful corrosion control is classified by the absence of localized corrosion and a general corrosion rate of less than about 2 mils per year (mpy), as measured on corrosion coupons or heat exchanger tubes.

Thus, there remains a need for water treatment compositions and methods of using them to inhibit corrosion in industrial systems, which meet industrial standards but contain chemical components that are more environmentally friendly. The invention provides such water treatment compositions and methods of using them to inhibit corrosion in industrial systems. These and other advantages of the invention, as well as additional inventive features, will be apparent from the description of the invention provided herein.

### BRIEF SUMMARY OF THE INVENTION

The invention provides a water treatment composition which includes a cathodic inhibitor comprising at least one rare earth metal; an anodic inhibitor comprising at least one polycarboxylic acid; and a polymer dispersant comprising at least one sulfonic group.

The invention further provides a method of inhibiting corrosion of a metal in an industrial water system, which method includes treating water of the industrial water system with a corrosion inhibiting-effective amount of a composition comprising a cathodic inhibitor comprising at least one rare earth metal; an anodic inhibitor comprising at least one polycarboxylic acid; and a polymer dispersant comprising at least one sulfonic group, to treat the water.

### DETAILED DESCRIPTION OF THE INVENTION

The invention provides a water treatment composition which includes a cathodic inhibitor comprising at least one rare earth metal; an anodic inhibitor comprising at least one polycarboxylic acid; and a polymer dispersant comprising at least one sulfonic group.

The cathodic inhibitor used in the water treatment composition of the invention may include any suitable rare earth metal or combination of rare earth metals. Suitable rare earth metals may include, for example, cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). In certain embodiments, the rare earth metal is lanthanum (La), cerium (Ce), yttrium (Y), or a combination thereof.

The rare earth metal(s) used in the cathodic inhibitor can present or added to the water treatment composition in any suitable form. For example, the rare earth metal(s) can be present or added to the water treatment composition as a salt, as a metal in an organic framework or complex, as an organometallic reagent, as a Lewis acid, as a neutral metal, as a hydrate, as an ion, or any combination thereof. For example, lanthanum may be present or added to the water treatment composition as LaCl₃7H₂O, cerium may be present or added to the water treatment composition added as CeCl₃7H₂O, and yttrium may be present or added to the water treatment composition added as YCl₃6H₂O.

The anodic inhibitor used in the water treatment composition of the invention may include any suitable polycarboxylic acid or combination of polycarboxylic acids. Each polycarboxylic acid used in the anodic inhibitor may include two or more carboxylic acids. For example, the polycarboxylic acid may include two carboxylic acids, three carboxylic acids, four carboxylic acids, five carboxylic acids, six carboxylic acids, or more. In some embodiments, the polycarboxylic acid includes a hydroxy polycarboxylic acid. In other words, the water treatment composition can comprise at least one polycarboxylic acid which includes two or more carboxylic acids and one or more hydroxyl groups. For example, the polycarboxylic acid can comprise one hydroxyl substituent, two hydroxyl substituents, three hydroxyl substituents, four hydroxyl substituents, five hydroxyl substituents, six hydroxyl substituents, or more than six hydroxyl substituents. In some embodiments, the anodic inhibitor comprises at least two (i.e., two or more) carboxylic acids and at least two (i.e., two or more) hydroxyl moieties.

Exemplary anodic inhibitors include, but are not limited to, tartaric acid, citric acid, malic acid, ascorbic acid, glucaric acid, coumaric acid, propionic acid, oxobutyric acid, 2,3-pyridinedicaroboxylic acid, 4,5-imidazoledicarboxylic acid, 1,2,3,4-butanetetracarboxylic acid (BTCA), polyepoxysuccinic acid (PESA), salts thereof, or a combination thereof. In certain embodiments, the anodic inhibitor incudes tartaric acid or a salt thereof.

Any suitable polymer dispersant comprising at least one sulfonic group may be used in the water treatment composition of the invention. As used herein, “sulfonic group” refers to any oxidized sulfur containing moiety. In some embodiments, the sulfonic group is of the formula —S(═O)₂—OH or a salt thereof. The sulfonic group can be incorporated into the polymer dispersant as a monomeric component or can be added or grafted to the polymer post-polymerization as a chemical modification. In some embodiments, the sulfonic group can be incorporated into the polymer dispersant by chemically incorporating at least one monomeric component selected from acrylamidomethanesulfonic acid, (dimethyl(2-oxobut-3-en-1-yl)ammonio)methanesulfonate, allyloxypolethoxy(10) sulfonic acid, 2-acrylamido-2-methylpropane sulfonic acid (i.e., 2-acrylamido-2-methyl-1-propanesulfonic acid or AMPS), 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and combinations thereof.

The polymer dispersant comprising at least one sulfonic group may further include any suitable additional monomeric component without a sulfonic group. For example, the polymer dispersant may further include at least one monomeric component selected from (meth)acrylamide, (meth)acrylic acid, itaconic acid, maleic anhydride, crotonic acid, acrylamido glycolic acid, salicylic acrylamido glycolic acid, allylmalonic acid dimethyl ester, 2-caroxyethyl acrylate, 3-acrylamido-3-methylbutanoic acid, salts thereof, and combinations thereof.

In some embodiments, the dispersant is a copolymer of at least one monomeric component selected from acrylamidomethanesulfonic acid, (dimethyl(2-oxobut-3-en-1-yl)ammonio)methanesulfonate, allyloxypolethoxy(10) sulfonic acid, 2-acrylamido-2-methylpropane sulfonic acid (i.e., 2-acrylamido-2-methyl-1-propanesulfonic acid or AMPS), 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and combinations thereof and at least one monomeric component selected from (meth)acrylamide, (meth)acrylic acid, itaconic acid, maleic anhydride, crotonic acid, acrylamido glycolic acid, salicylic acrylamido glycolic acid, allylmalonic acid dimethyl ester, 2-caroxyethyl acrylate, 3-acrylamido-3-methylbutanoic acid, salts thereof, and combinations thereof. In certain embodiments, the dispersant is a copolymer of 2-acrylamido-2-methylpropane sulfonic acid (i.e., 2-acrylamido-2-methyl-1-propanesulfonic acid or AMPS) and at least one monomeric component selected from (meth)acrylamide, (meth)acrylic acid, and combinations thereof. In preferred embodiments, the dispersant is a copolymer of 2-acrylamido-2-methylpropane sulfonic acid (i.e., 2-acrylamido-2-methyl-1-propanesulfonic acid or AMPS) and (meth)acrylic acid.

The polymer dispersant comprising at least one sulfonic group may have any suitable weight average molecular weight. For instance, the polymer dispersant comprising at least one sulfonic group may have a weight average molecular weight of about 500 g/mol or more, for example, about 750 g/mol or more, about 1,000 g/mol or more, about 1,500 g/mol or more, about 2,000 g/mol or more, about 2,500 g/mol or more, about 3,000 g/mol or more, about 3,500 g/mol or more, about 4,000 g/mol or more, about 4,500 g/mol or more, about 5,000 g/mol or more, about 5,500 g/mol or more, about 6,000 g/mol or more, about 6,500 g/mol or more, about 7,000 g/mol or more, or about 7,500 g/mol or more. Alternatively, or additionally, the polymer dispersant comprising at least one sulfonic group may have a weight average molecular weight of about 20,000 g/mol or less, for example, about 15,000 g/mol or less, about 10,000 g/mol or less, for example, about 9,000 g/mol or less, about 8,000 g/mol or less, about 7.500 g/mol or less, about 7,000 g/mol or less, about 6,500 g/mol or less, about 6,000 g/mol or less, about 5,500 g/mol or less, about 5.000 g/mol or less, about 4,500 g/mol or less, about 4.000 g/mol or less, about 3,500 g/mol or less, about 3,000 g/mol or less, about 2,500 g/mol or less, or about 2,000 g/mol or less. Thus, the polymer dispersant comprising at least one sulfonic group may have a weight average molecular weight bounded by any two of the aforementioned endpoints. For example, the polymer dispersant comprising at least one sulfonic group may have a weight average molecular weight of about 500 g/mol to about 20,000 g/mol, e.g., about 500 g/mol to about 15,000 g/mol, about 500 g/mol to about 10,000 g/mol, about 500 g/mol to about 5,000 g/mol, about 1,000 g/mol to about 20,000 g/mol, about 1,000 g/mol to about 15,000 g/mol, about 1,000 g/mol to about 10,000 g/mol, about 1,000 g/mol to about 5,000 g/mol, or about 2,000 g/mol to about 20,000 g/mol.

In some embodiments, the water treatment composition further comprises silica or a silicate. As used herein, “silica” refers to any mineral or synthetic product of the formula SiO₂, or a hydrate thereof, and “silicate” refers to any salt with an anionic component that contains silicon and oxygen atoms. For example, the silicate may include any salt comprising SiO₄²⁻ as the anion, e.g., sodium silicate. In some embodiments, the water treatment composition further comprises silica (SiO₂).

In some embodiments, the water treatment composition further includes at least one scale inhibitor. The scale inhibitor can be any suitable scale inhibitor including those which are known to those skilled in the art. Exemplary scale inhibitors include, but are not limited to, polymaleic acid, poly(methyl)acrylic acid, polyepoxy succinic acid (PESA), polyaspartic acid (PASP), salts thereof, or a combination thereof. In some embodiments, the water treatment composition further comprises a scale inhibitor which includes polymaleic acid.

The water treatment composition may further include at least one azole-based corrosion inhibitor. As used herein, “azole-based corrosion inhibitor” refers to any chemical compound that inhibits corrosion and includes an azole moiety. Examples of azole-based corrosion inhibitors include, but are not limited to, benzotriazole (BZT), tolyltriazole (TT), 5-methylbenzotriazole (5-MeBT), 4-methylbenzotriazole (4-MeBT), butylbenzotriazole (BBT), pentoxybenzotriazole (POBT), carboxylbenzotriazole (CBT), tetrahydrotolyltriazole (THT), a halogen resistant azole (HRA, e.g., chlorobenzotriazole or chlorotolyltriazole), salts thereof, or a combination thereof. In certain embodiments, however, the water treatment composition does not contain an azole-based corrosion inhibitor.

In some embodiments, the water treatment composition further includes a carrier. The carrier may include any suitable component that increases the miscibility of the water treatment composition in water. For example, the carrier may simply include water and/or may include a water-miscible co-solvent such as, for example, acetone, methanol, ethanol, propanol, formic acid, formamide, propylene glycol, ethylene glycol, or combinations thereof.

In some embodiments, the water treatment composition of the invention may include a trace amount of zinc. For example, it is possible that impurities in the components or in the water or treated water may contribute trace quantities of zinc to the system. Accordingly, it is contemplated that zinc may be present in low concentrations, e.g., of about 100 ppb or less, e.g., about 50 ppb or less, about 10 ppb or less, or about 1 ppb or less. Preferably, the water treatment composition of the invention contains no zinc at all, or an undetectable amount of zinc.

In some embodiments, the water treatment composition of the invention may include a trace amount of phosphorus. For example, it is possible that impurities in the components or in the water or treated water may contribute trace quantities of phosphorus to the system. Accordingly, it is contemplated that phosphorus may be present in low concentrations, e.g., of about 100 ppb or less, e.g., about 50 ppb or less, about 10 ppb or less, or about 1 ppb or less. Preferably, the water treatment composition of the invention contains no phosphorus at all, or an undetectable amount of phosphorus.

As used herein, “water treatment composition” may refer to a composition used to treat an industrial water system (i.e., a composition to be added to the industrial water system to treat the water used in the system) or an industrial water system that has been treated with such a composition (i.e., wherein the components described herein have already been added to the industrial water system to form a treated industrial water system). In other words, “water treatment composition” may refer to the composition of the invention that is used for treating water or treated water obtained after treating water with the components described herein.

In some embodiments, the water treatment composition of the invention, which is to be added to an industrial water system, may be supplied, for example, as a one-package system comprising the cathodic inhibitor, anodic inhibitor, polymer dispersant, and any further optional components. Alternatively, the water treatment composition of the invention can be supplied as a two-package system, three-package system, four-package system, five-package system, six-package system, or as a multi-component system with more than six packages, comprising the cathodic inhibitor, anodic inhibitor, polymer dispersant, and/or any further optional components as individual additives. In some embodiments, a multi-component system may allow for the adjustment of relative amounts of the cathodic inhibitor, anodic inhibitor, polymer dispersant, and any further optional components by changing the blending ratio of the components. Various methods can be employed to utilize such a multi-package system. For example, the components can pre-mixed at the point-of use, or the components can be delivered to the industrial water system individually or together using the same mechanism of addition or using different mechanisms of addition. The components may be delivered sequentially or at the same time. As used herein, “point-of-use” refers to the point at which the water treatment composition is introduced to the industrial water system.

The components of the water treatment composition can be delivered to the point-of-use independently (such that the components are mixed together by way of their addition to the industrial process), or one or more of the components can be combined/mixed together before delivery to the point-of-use, e.g., shortly or immediately before delivery to the point-of-use. By “immediately before delivery to the point-of-use” includes situations in which the components are combined about 5 minutes or less prior to being delivered in mixed form to the point-of-use, for example, about 4 minutes or less, about 3 minutes or less, about 2 minutes or less, about 1 minute or less, about 45 seconds or less, about 30 seconds or less, or about 10 seconds or less prior to being added in mixed form, or simultaneously delivering the components, at the point-of-use. Components also are combined “immediately before the point-of-use” if the components are combined within 5 m of the point-of-use, such as within 1 m of the point-of-use or even within 10 cm of the point-of-use (e.g., within 1 cm of the point-of-use).

The water treatment composition also may be provided as a concentrate which is intended to be diluted with an appropriate amount of water or other carrier prior to use, or diluted with the appropriate amount of water at the point-of-use (i.e., with the industrial water). In such an embodiment, the water treatment composition concentrate may include the components of the water treatment composition in amounts such that, upon dilution of the concentrate with an appropriate amount of water, each component of the water treatment composition will be present in the industrial water system in a concentration that is within the range needed for each component to serve its intended purpose. For example, the cathodic inhibitor, anodic inhibitor, polymer dispersant, and any further optional components can each be present in the concentrate in an amount that is about 2 times (e.g., about 3 times, about 4 times, or about 5 times) greater than the range needed for each component to serve its intended purpose so that, when the concentrate is diluted with an equal volume of water (e.g., 2 equal volumes water, 3 equal volumes of water, or 4 equal volumes of water, respectively), each component will be present in the industrial water system in the concentration range needed for each component to serve its intended purpose.

In view of the foregoing, the water treatment composition of the invention may include any suitable amount of the cathodic inhibitor, anodic inhibitor, polymer dispersant, and any further optional components. The water treatment composition of the invention may include, for example, from about 0.1 ppm to about 1,000 ppm of the cathodic inhibitor, e.g., from about 0.1 ppm to about 500 ppm, from about 0.1 ppm to about 100 ppm, from about 0.1 ppm to about 50 ppm, from about 0.1 ppm to about 10 ppm, or from about 2 ppm to about 5 ppm. The water treatment composition of the invention may include, e.g., from about 1 ppm to about 10,000 ppm of the anodic inhibitor, e.g., from about 1 ppm to about 5,000 ppm, from about 1 ppm to about 1,000 ppm, from about 1 ppm to about 500 ppm, from about 1 ppm to about 100 ppm, from about 1 ppm to about 50 ppm, or from about 5 ppm to about 20 ppm. The water treatment composition can comprise from about 1 ppm to about 5,000 ppm of the polymer dispersant, e.g., from about 1 ppm to about 1,000 ppm, from about 1 ppm to about 500 ppm, from about 1 ppm to about 100 ppm, from about 1 ppm to about 50 ppm, or from about 2 ppm to about 20 ppm. The water treatment composition of the invention may include, e.g., from 0 ppm to about 10,000 ppm of the silica or silicate, e.g., from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm. The water treatment composition of the invention may include, e.g., from 0 ppm to about 10,000 ppm of the scale inhibitor, e.g., from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm. The water treatment composition of the invention may include, e.g., from 0 ppm to about 10,000 ppm of the azole-based corrosion inhibitor, e.g., from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm. Thus, the water treatment composition of the invention may include, e.g., any combination of these components in any amount described herein.

The invention further provides a method of inhibiting corrosion of a metal in an industrial water system, the method comprising treating water of the industrial water system with a corrosion inhibiting-effective amount of a cathodic inhibitor comprising at least one rare earth metal; an anodic inhibitor comprising at least one polycarboxylic acid; and a polymer dispersant comprising at least one sulfonic group, to provide a treated water. The cathodic inhibitor, anodic inhibitor, and/or polymer dispersant may be added to the water (e.g., water of the industrial water system) separately. Alternatively, the cathodic inhibitor, anodic inhibitor, and/or polymer dispersant may be added to the water (e.g., water of the industrial water system) as a single composition.

As used herein, “industrial water system” means any system that circulates water as part of an industrially applicable process. Non-limiting examples of industrial water systems include cooling systems, boiler systems, heating systems, membrane systems, paper making processes, or any other systems that circulate water as part of an industrially applicable. In certain embodiments, the industrial water system is a cooling water system such as, for example, an open loop cooling system, a closed loop cooling system, a passivation cooling system, or a combination thereof.

As used herein, “water” refers to any substance that includes water as a primary ingredient. Water may include, for example, purified water, tap water, fresh water, recycled water, brine, steam, and/or any aqueous solution, or aqueous blend.

The components of the water treatment composition of the invention are intended to inhibit the corrosion of a metal surface that may come into contact with water used in an industrial water system. In certain embodiments, the components of the water treatment composition may be contacted with a metal surface by immersion, spraying, or other coating techniques. In other embodiments, the components of the water treatment composition or a solution thereof may be introduced into the water of the industrial water system by any conventional method and, if desired, may be fed into the industrial water system on either a periodic or continuous basis.

As used herein, “metal” refers to any metal or metal alloy including, but not limited to, stainless steel, alloy steel, galvanized steel, tool steel, mild steel, aluminum, brass, bronze, iron, or copper. In some embodiments, the metal is copper. Copper has a wide-range of applications, including use as piping and tubing in plumbing and industrial machinery. Copper and copper alloys are well known for their use in cooling water and boiler water systems. In some embodiments, the metal is a copper alloy such as bronze and brass. Bronze commonly includes copper and tin, but may further include other elements such as, e.g., aluminum, manganese, silicon, arsenic, and phosphorus. Brass typically includes copper and zinc, and is commonly used in piping in water boiler systems. In some embodiments, the metal is mild steel. As used herein, “mild steel” refers to carbon and low alloy steels.

The treated water may include from about 0.1 ppm to about 1,000 ppm of the cathodic inhibitor, e.g., from about 0.1 ppm to about 500 ppm, from about 0.1 ppm to about 100 ppm, from about 0.1 ppm to about 50 ppm, from about 0.1 ppm to about 10 ppm, or from about 2 ppm to about 5 ppm. In certain embodiments, the treated water includes from about 0.1 ppm to about 10 ppm of the cathodic inhibitor. In some embodiments, the treated water includes from about 2 ppm to about 5 ppm of the cathodic inhibitor.

The treated water may include from about 1 ppm to about 10,000 ppm of the anodic inhibitor, e.g., from about 1 ppm to about 5,000 ppm, from about 1 ppm to about 1,000 ppm, from about 1 ppm to about 500 ppm, from about 1 ppm to about 100 ppm, from about 1 ppm to about 50 ppm, or from about 5 ppm to about 20 ppm. In certain embodiments, the treated water includes from about 1 ppm to about 100 ppm of the anodic inhibitor. In some embodiment, the treated water includes from about 5 ppm to about 20 ppm of the anodic inhibitor.

The treated water may include from about 1 ppm to about 5,000 ppm of the polymer dispersant, e.g., from about 1 ppm to about 1,000 ppm, from about 1 ppm to about 500 ppm, from about 1 ppm to about 100 ppm, from about 1 ppm to about 50 ppm, or from about 2 ppm to about 20 ppm. In certain embodiments, the treated water includes from about 1 ppm to about 50 ppm of the polymer dispersant. In some embodiments, the treated water comprises from about 2 ppm to about 20 ppm of the polymer dispersant.

In some embodiments, the method of the invention further includes treating the water (e.g., water of the industrial water system) with silica or a silicate. Accordingly, the treated water may include from 0 ppm to about 10,000 ppm of the silica or silicate, e.g., from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm. In certain embodiments, the treated water includes from about 1 ppm to about 100 ppm of the silica or a silicate.

In some embodiments, the method of the invention further includes treating the water (e.g., water of the industrial water system) with a scale inhibitor. Accordingly, the treated water may include from 0 ppm to about 10,000 ppm of the scale inhibitor, e.g., from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm. In certain embodiments, the treated water includes from about 1 ppm to about 100 ppm of the scale inhibitor.

In some embodiments, the method of the invention further includes treating the water (e.g., water of the industrial water system) with an azole-based corrosion inhibitor. Accordingly, the treated water may include from 0 ppm to about 10,000 ppm of the azole-based corrosion inhibitor, e.g., from about 1 ppm to about 10,000 ppm, from about 1 ppm to about 5,000 ppm, from about 1 ppm to about 1,000 ppm, from about 1 ppm to about 500 ppm, or from about 1 ppm to about 100 ppm.

The water or treated water of the industrial water system may have any suitable pH. For example, the water or treated water of the industrial water system may have a pH of from about 6 to about 12. Thus, in certain preferred embodiments, the water or treated water has a pH of from about 6 to about 12, from about 6 to about 11, from about 6 to about 10, from about 6 to about 9, from about 6 to about 8, from about 7 to about 12, from about 8 to about 12, from about 9 to about 12, from about 7 to about 10, or from about 8 to about 10.

The compositions and methods of the invention may inhibit corrosion caused by any corrosive compound that an industrial water system may include, produce, or come into contact with. For example, the compositions and methods of the invention may inhibit corrosion in the presence of oxidizing halogen compounds including, but not limited to, hypochlorite bleach, chlorine, bromine, hypochlorite, hypobromite, chlorine dioxide, iodine/hypoiodous acid, hypobromous acid, halogenated hydantoins, stabilized versions of hypochlorous or hypobromous acids, or combinations thereof. Alternatively, or additionally, the compositions and methods of the invention may inhibit corrosion in the presence of non-halogen-containing oxidizing biocide including, but not limited to, peroxides (e.g., hydrogen peroxide), persulfates, permanganates, and peracetic acids.

The compositions and methods of the invention are intended to provide a metal (e.g., mild steel) corrosion rate that is acceptable according to industry standards, e.g., about 2 mpy or less. In certain embodiments, the compositions and methods of the invention provide a metal (e.g., mild steel) corrosion rate of about 1 mpy or less, e.g., about 0.9 mpy or less, about 0.8 mpy or less, about 0.7 mpy or less, about 0.6 mpy or less, about 0.5 mpy or less, about 0.4 mpy, or about 0.3 mpy or less. In some embodiments, the compositions and methods of the invention provide a metal corrosion rate of about 0.1 mpy or less, about 0.05 mpy or less, about 0.04 mpy or less, about 0.03 mpy or less, about 0.02 mpy or less, about 0.01 mpy or less, about 0.005 mpy or less, or about 0.002 mpy or less.

### EMBODIMENTS

(1) In embodiment (1) is presented a water treatment composition comprising:

a cathodic inhibitor comprising at least one rare earth metal; an anodic inhibitor comprising at least one polycarboxylic acid; and a polymer dispersant comprising at least one sulfonic group.

(2) In embodiment (2) is presented the water treatment composition of embodiment (1), wherein the polycarboxylic acid is a hydroxy polycarboxylic acid.

(3) In embodiment (3) is presented the water treatment composition of embodiment (1) or embodiment (2), wherein the rare earth metal is lanthanum, cerium, or yttrium.

(4) In embodiment (4) is presented the water treatment composition of any one of embodiments (1)-(3), wherein the anodic inhibitor comprises tartaric acid, citric acid, malic acid, ascorbic acid, glucaric acid, coumaric acid, propionic acid, oxobutyric acid, 2,3-pyridinedicaroboxylic acid, 4,5-imidazoledicarboxylic acid, 1,2,3,4-butanetetracarboxylic acid (BTCA), polyepoxysuccinic acid (PESA), salts thereof, or a combination thereof.

(5) In embodiment (5) is presented the water treatment composition of any one of embodiments (1)-(3), wherein the polycarboxylic acid comprises at least two hydroxyl moieties.

(6) In embodiment (6) is presented the water treatment composition of any one of embodiments (1)-(5), wherein the polycarboxylic acid comprises tartaric acid or a salt thereof.

(7) In embodiment (7) is presented the water treatment composition of any one of embodiments (1)-(6), wherein the polymer dispersant comprises at least one monomeric component selected from acrylamidomethanesulfonic acid, (dimethyl(2-oxobut-3-en-1-yl)ammonio)methanesulfonate, allyloxypolethoxy(10) sulfonic acid, 2-acrylamido-2-methylpropane sulfonic acid, 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and combinations thereof.

(8) In embodiment (8) is presented the water treatment composition of embodiment (7), wherein the polymer dispersant further comprises at least one monomeric component selected from (meth)acrylamide, (meth)acrylic acid, itaconic acid, maleic anhydride, crotonic acid, acrylamido glycolic acid, salicylic acrylamido glycolic acid, allylmalonic acid dimethyl ester, 2-caroxyethyl acrylate, 3-acrylamido-3-methylbutanoic acid, salts thereof, and combinations thereof.

(9) In embodiment (9) is presented the water treatment composition of any one of embodiments (1)-(8), wherein the water treatment composition further comprises silica or a silicate.

(10) In embodiment (10) is presented the water treatment composition of any one of embodiments (1)-(9), wherein the water treatment composition further comprises at least one scale inhibitor.

(11) In embodiment (11) is presented the water treatment composition of embodiment (10), wherein the scale inhibitor comprises polymaleic acid, poly(methyl)acrylic acid, polyepoxy succinic acid (PESA), polyaspartic acid (PASP), salts thereof, or a combination thereof.

(12) In embodiment (12) is presented the water treatment composition of any one of embodiments (1)-(11), wherein the water treatment composition further comprises at least one azole-based corrosion inhibitor.

(13) In embodiment (13) is presented the water treatment composition of embodiment (12), wherein the azole-based corrosion inhibitor is benzotriazole (BZT), tolyltriazole (TT), 5-methylbenzotriazole (5-MeBT), 4-methylbenzotriazole (4-MeBT), butylbenzotriazole (BBT), pentoxybenzotriazole (POBT), carboxylbenzotriazole (CBT), tetrahydrotolyltriazole (THT), a halogen resistant azole (HRA, e.g., chlorobenzotriazole or chlorotolyltriazole), salts thereof, or a combination thereof.

(14) In embodiment (14) is presented a method of inhibiting corrosion of a metal in an industrial water system, the method comprising: treating water of the industrial water system with a corrosion inhibiting-effective amount of: a cathodic inhibitor comprising at least one rare earth metal; an anodic inhibitor comprising at least one polycarboxylic acid; and a polymer dispersant comprising at least one sulfonic group, to provide treated water.

(15) In embodiment (15) is presented the method of embodiment (14), wherein the polycarboxylic acid comprises a hydroxy polycarboxylic acid.

(16) In embodiment (16) is presented the method of embodiment (14) or (15), wherein the rare earth metal comprises lanthanum, cerium, or yttrium.

(17) In embodiment (17) is presented the method of any one of embodiments (14)-(16), wherein the anodic inhibitor comprises tartaric acid, citric acid, malic acid, ascorbic acid, glucaric acid, coumaric acid, propionic acid, oxobutyric acid, 2,3-pyridinedicaroboxylic acid, 4,5-imidazoledicarboxylic acid, 1,2,3,4-butanetetracarboxylic acid (BTCA), polyepoxysuccinic acid (PESA), salts thereof, or a combination thereof.

(18) In embodiment (18) is presented the method of any one of embodiments (14)-(16), wherein the polycarboxylic acid comprises at least two hydroxyl moieties.

(19) In embodiment (19) is presented the method of any one of embodiments (14)-(18), wherein the anodic inhibitor comprises tartaric acid or a salt thereof.

(20) In embodiment (20) is presented the method of any one of embodiments (14)-(19), wherein the polymer dispersant comprises at least one monomeric component selected from acrylamidomethanesulfonic acid, (dimethyl(2-oxobut-3-en-1-yl)ammonio)methanesulfonate, allyloxypolethoxy(10) sulfonic acid, 2-acrylamido-2-methylpropane sulfonic acid, 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and combinations thereof.

(21) In embodiment (21) is presented the method of embodiment (20), wherein the polymer dispersant further comprises at least one monomeric component selected from (meth)acrylamide, (meth)acrylic acid, itaconic acid, maleic anhydride, crotonic acid, acrylamido glycolic acid, salicylic acrylamido glycolic acid, allylmalonic acid dimethyl ester, 2-caroxyethyl acrylate, 3-acrylamido-3-methylbutanoic acid, salts thereof, and combinations thereof.

(22) In embodiment (22) is presented the method of any one of embodiments (14)-(21), wherein the treated water comprises from about 0.1 ppm to about 10 ppm of the cathodic inhibitor.

(23) In embodiment (23) is presented the method of embodiment (22), wherein the treated water comprises from about 2 ppm to about 5 ppm of the cathodic inhibitor.

(24) In embodiment (24) is presented the method of any one of embodiments (14)-(23), wherein the treated water comprises from about 1 ppm to about 100 ppm of the anodic inhibitor.

(25) In embodiment (25) is presented the method of embodiment (25), wherein the treated water comprises from about 5 ppm to about 20 ppm of the anodic inhibitor.

(26) In embodiment (26) is presented the method of any one of embodiments (14)-(25), wherein the treated water comprises from about 1 ppm to about 50 ppm of the polymer dispersant.

(27) In embodiment (27) is presented the method of embodiment (26), wherein the treated water comprises from about 2 ppm to about 20 ppm of the polymer dispersant.

(28) In embodiment (28) is presented the method of any one of embodiments (14)-(27), wherein the cathodic inhibitor, anodic inhibitor, and polymer dispersant are added to the water separately.

(29) In embodiment (29) is presented the method of any one of embodiments (14)-(27), wherein the cathodic inhibitor, anodic inhibitor, and polymer dispersant are added to the water simultaneously or as a mixture.

(30) In embodiment (30) is presented the method of any one of embodiments (14)-(29), wherein the method further comprises treating the water with silica or a silicate.

(31) In embodiment (31) is presented the method of embodiment (30), wherein the treated water comprises from about 1 ppm to about 100 ppm of the silica or a silicate.

(32) In embodiment (32) is presented the method of any one of embodiments (14)-(31), wherein the method further comprises treating the water with a scale inhibitor.

(33) In embodiment (33) is presented the method of embodiment (32), wherein the treated water comprises from about 1 ppm to about 100 ppm of the scale inhibitor.

(34) In embodiment (34) is presented the method of embodiment (32) or (33), wherein the scale inhibitor is polymaleic acid, poly(methyl)acrylic acid, polyepoxy succinic acid (PESA), polyaspartic acid (PASP), salts thereof, or a combination thereof.

(35) In embodiment (35) is presented the method of any one of embodiments (14)-(34), wherein the method further comprises treating the water with an azole-based corrosion inhibitor.

(36) In embodiment (36) is presented the method of embodiment (35), wherein the azole-based corrosion inhibitor is benzotriazole (BZT), tolyltriazole (TT), 5-methylbenzotriazole (5-MeBT), 4-methylbenzotriazole (4-MeBT), butylbenzotriazole (BBT), pentoxybenzotriazole (POBT), carboxylbenzotriazole (CBT), tetrahydrotolyltriazole (THT), a halogen resistant azole (HRA, e.g., chlorobenzotriazole or chlorotolyltriazole), salts thereof, or a combination thereof.

(37) In embodiment (37) is presented the method of any one of embodiments (14)-(36), wherein the industrial water system is a cooling water system.

(38) In embodiment (38) is presented the method of embodiment (37), wherein the cooling water system is an open loop system, a closed loop system, a passivation system, or a combination thereof.

(39) In embodiment (39) is presented the method of any one of embodiments (14)-(38), wherein the metal is stainless steel, alloy steel, galvanized steel, tool steel, mild steel, aluminum, brass, bronze, iron, or copper.

(40) In embodiment (40) is presented the method of embodiment (39), wherein the metal is mild steel or brass.

### EXAMPLES

The following examples further illustrate the invention but, of course, should not be construed as in any way limiting its scope.

For each of Examples 1-3, corrosion of carbon steel was monitored using electrochemical analysis in a 10.8 L test cell. Performance was evaluated for soft water (Sample A), Yangze River water (Sample B), and high chloride water (Sample C) with chemical concentrations summarized in Table 1.

TABLE 1
Water Samples Tested

| | Sample A (ppm) | Sample B (ppm) | Sample C (ppm) |
|---|---|---|---|
| Ca (as CaCO₃) | 200 | 400 | 550 |
| Mg (as CaCO₃) | 50 | 165 | 380 |
| M-Alkalinity | 225 | 250 | 200 |
| (as CaCO₃) | | | |
| Cl (as ion) | 120 | 200 | 600 |
| SO₄ (as ion) | 70 | 350 | 600 |

The 10.8 L test cells were equipped with a Gamry system (PCI4G300), associated with a PINE rotator, which was used to detect and record the electrochemical signals. Up to eight 10.8 L cells can be run simultaneously using a Multiplexer (ECM8) to accommodate data collection. For these experiments, the reference electrodes (RE) were Ag/AgCl, the counter electrodes (CE) were graphite electrodes, and the working electrodes (WE) were 5 cm² carbon steel. The corrosion rate was measured in mils per year (mpy), which is a directed representation of the material loss or weight loss of a metal surface due to corrosion.

### Example 1

This example demonstrates the beneficial corrosion inhibition performance of a composition comprising a cathodic inhibitor, an anodic inhibitor, and a polymer dispersant.

Soft water (Sample A), Yangze River water (Sample B), and high chloride water (Sample C) were treated with corrosion inhibition compositions containing a cathodic inhibitor (lanthanum, cerium, or yttrium), an anodic inhibitor (tartaric acid), and a polymer dispersant (poly(AA/AMPS), a copolymer of 2-acrylamido-2-methyl-1-propanesulfonic acid and acrylic acid). For these compositions, the lanthanum was added as LaCl₃7H₂O, the cerium was added as CeCl₃7H₂O, and the yttrium was added as YCl₃6H₂O. The compositions optionally further contained a scale inhibitor (polymaleic acid) and silicon dioxide (SiO₂). The resulting inventive corrosion inhibiting compositions are summarized in Table 2.

TABLE 2
Inventive Corrosion Inhibition Compositions

| | Cathodic | Tartaric | Poly | | |
|---|---|---|---|---|---|
| | Inhibitor | Acid | (AA/AMPS) | Polymaleic | SiO₂ |
| Composition | (ppm) | (ppm) | (ppm) | acid (ppm) | (ppm) |
| Inventive 1A | La (2.5) | 10 | 6 | 7 | 25 |
| Inventive 1B | Ce (2.5) | 10 | 6 | 7 | 25 |
| Inventive 1C | La (2.5) | 10 | 6 | 8 | 25 |
| Inventive 1D | Ce (2.5) | 10 | 6 | 8 | 25 |
| Inventive 1E | Y (2.5) | 10 | 6 | 20 | 0 |
| Inventive 1F | La (2.5) | 10 | 6 | 8 | 25 |
| Inventive 1G | Ce (2.5) | 10 | 6 | 8 | 25 |
| Inventive 1H | Y (2.5) | 10 | 6 | 20 | 0 |

Inventive corrosion inhibiting compositions 1A-1H presented in Table 2 were combined with soft water (Sample A), Yangze River water (Sample B), and high chloride water (Sample C), and the resulting mixtures are summarized in Table 3. These mixtures were contacted with carbon steel for a period of 24 hours at a temperature of 43° C. or 50° C. and the corrosion rate was measured in mils per year (mpy) and the results are set forth in Table 3.

TABLE 3
Corrosion Inhibition Rate

| Composition | Water Matrix | pH | Temp (° C.) | Corrosion Rate (mpy) |
|---|---|---|---|---|
| Inventive 1A | Sample A | 8.8 | 43 | 0.05 |
| Inventive 1B | Sample A | 8.8 | 43 | 0.04 |
| Inventive 1C | Sample B | 8.7 | 43 | 0.11 |
| Inventive 1D | Sample B | 8.7 | 43 | 0.25 |
| Inventive 1E | Sample B | 8.6 | 50 | 0.67 |
| Inventive 1F | Sample C | 8.7 | 43 | 0.90 |
| Inventive 1G | Sample C | 8.7 | 43 | 0.60 |
| Inventive 1H | Sample C | 8.6 | 50 | 0.63 |

The Association of Water Technologies (AWT) considers corrosion rates of 1 mpy or less for carbon steel in open recirculating cooling water systems to be negligible or excellent.

As is apparent from the results set forth in Table 3, each of inventive corrosion inhibiting compositions 1A-1H provide a corrosion rate of less than 1 mpy for carbon steel. Thus, the corrosion rate of carbon steel in the presence of inventive corrosion inhibiting compositions 1A-1H is considered negligible or excellent. In addition, Table 3 shows that the inventive compositions provided significantly less than 1 mpy corrosion for carbon steel when used in soft water (Sample A) and Yangze River water (Sample B), indicating that inventive compositions 1A-1E provide excellent corrosion inhibition when contacted with soft water and medium water.

### Example 2

This example demonstrates the beneficial corrosion inhibition performance of a composition comprising a cathodic inhibitor, an anodic inhibitor, and a polymer dispersant when used in the treatment of hard water such as high chloride water (Sample C).

High chloride water (Sample C) was treated with corrosion inhibition compositions containing a cathodic inhibitor (lanthanum), an anodic inhibitor (tartaric acid), and a polymer dispersant (poly(AA/AMPS), a copolymer of 2-acrylamido-2-methyl-1-propanesulfonic acid and acrylic acid). For these compositions, the lanthanum was added as LaCl₃7H₂O. The compositions further contained a scale inhibitor (polymaleic acid). The resulting inventive corrosion inhibiting compositions are summarized in Table 4. Comparative composition 2E did not contain an anodic inhibitor (tartaric acid).

TABLE 4
Lanthanum-Based Corrosion Inhibition Compositions
(High Chloride Water)

| | Cathodic | Tartaric | Poly | |
|---|---|---|---|---|
| | Inhibitor | Acid | (AA/AMPS) | Polymaleic |
| Composition | (ppm) | (ppm) | (ppm) | acid (ppm) |
| Inventive 2A | La (2.5) | 50 | 6 | 20 |
| Inventive 2B | La (2.5) | 50 | 10 | 20 |
| Inventive 2C | La (2.5) | 50 | 6 | 10 |
| Inventive 2D | La (5.0) | 50 | 16 | 20 |
| Comparative 2E | La (5.0) | 0 | 16 | 50 |

Inventive corrosion inhibiting compositions 2A-2D and comparative corrosion inhibiting composition 2E presented in Table 4 were combined with high chloride water (Sample C) and the resulting mixtures are summarized in Table 5. These mixtures were contacted with carbon steel for a period of 24 hours at a temperature of 50° C. and the corrosion rate was measured in mils per year (mpy) and the results are set forth in Table 5. The reported corrosion rate is an average of the corrosion rate at steady phase, accounting for statistical outliers.

TABLE 5
Corrosion Inhibition Rate for High Chloride Water

| | | | Temp | Corrosion Rate |
|---|---|---|---|---|
| Composition | Water Matrix | pH | (° C.) | (mpy) |
| Inventive 2A | Sample C | 8.6 | 50 | 0.34 |
| Inventive 2B | Sample C | 8.6 | 50 | 0.17 |
| Inventive 2C | Sample C | 8.6 | 50 | 0.52 |
| Inventive 2D | Sample C | 8.6 | 50 | 0.15 |
| Comparative 2E | Sample C | 8.6 | 50 | 0.57 |

As is apparent from the results set forth in Table 5, comparative corrosion inhibiting composition 2E, not containing an anodic inhibitor (tartaric acid), was significantly outperformed by inventive corrosion inhibiting compositions 2A, 2B, and 2D. Thus, the anodic inhibitor is a necessary component of the corrosion inhibiting composition. In addition, Table 5 shows that inventive corrosion inhibiting composition 2C, containing less scale inhibitor (polymaleic acid), did not inhibit the corrosion of carbon steel as much as inventive corrosion inhibiting compositions 2A, 2B, and 2D. Thus, the scale inhibitor appears to further enhance the corrosion inhibition properties of the corrosion inhibiting compositions.

### Example 3

This example demonstrates the beneficial corrosion inhibition performance of a composition comprising a cathodic inhibitor, an anodic inhibitor, and a polymer dispersant when used in the treatment of moderate water such as Yangze River water (Sample B).

Yangze River water (Sample B) was treated with corrosion inhibition compositions containing a cathodic inhibitor (lanthanum), an anodic inhibitor (tartaric acid), and a polymer dispersant (poly(AA/AMPS), a copolymer of 2-acrylamido-2-methyl-1-propanesulfonic acid and acrylic acid). For these compositions, the lanthanum was added as LaCl₃7H₂O. The compositions optionally further contained a scale inhibitor (polymaleic acid) and silicon dioxide (SiO₂). The resulting inventive corrosion inhibiting compositions are summarized in Table 6. Comparative corrosion inhibiting composition 3C did not contain an anodic inhibitor, comparative corrosion inhibiting composition 3D did not contain a polymer dispersant, and comparative corrosion inhibiting composition 3E did not contain an anodic inhibitor nor a polymer dispersant.

TABLE 6
Lanthanum-Based Corrosion Inhibition Compositions
(Yangze River Water)

| | Cathodic | Tartaric | Poly | | |
|---|---|---|---|---|---|
| | Inhibitor | Acid | (AA/AMPS) | Polymaleic | SiO₂ |
| Composition | (ppm) | (ppm) | (ppm) | acid (ppm) | (ppm) |
| Inventive 3A | La (2.5) | 10 | 6 | 20 | 25 |
| Inventive 3B | La (2.5) | 10 | 6 | 20 | 0 |
| Comparative 3C | La (2.5) | 0 | 6 | 20 | 25 |
| Comparative 3D | La (2.5) | 10 | 0 | 20 | 25 |
| Comparative 3E | La (2.5) | 0 | 0 | 20 | 0 |

Inventive corrosion inhibiting compositions 3A and 3B, and comparative corrosion inhibiting compositions 3C-3E presented in Table 6 were combined with Yangze River water (Sample B) and the resulting mixtures are summarized in Table 7. These mixtures were contacted with carbon steel for a period of 24 hours at a temperature of 50° C. and the corrosion rate was measured in mils per year (mpy). The reported corrosion rate is an average of the corrosion rate at steady phase, accounting for statistical outliers. In addition, the turbidity was measured at time point 0 and after 24 hours. The results are set forth in Table 7.

TABLE 7
Corrosion Inhibition Rate for Yangze River Water

| | | | | Initial | Final | Corrosion |
|---|---|---|---|---|---|---|
| | Water | | Temp | Turbidity | Turbidity | Rate |
| Composition | Matrix | pH | (° C.) | (NTU) | (NTU) | (mpy) |
| Inventive 3A | Sample B | 8.6 | 50 | 1.55 | 2.56 | 0.43 |
| Inventive 3B | Sample B | 8.6 | 50 | 2.7 | 3.35 | 0.34 |
| Comparative 3C | Sample B | 8.6 | 50 | 4.71 | 6.38 | 0.68 |
| Comparative 3D | Sample B | 8.6 | 50 | 2.15 | 2.22 | 0.65 |
| Comparative 3E | Sample B | 8.6 | 50 | 4.51 | 4.31 | 5.50 |

As is apparent from the results set forth in Table 7, inventive corrosion inhibiting compositions 3A and 3B significantly outperformed comparative corrosion inhibiting compositions 3C-3E, which did not contain an anodic inhibitor and/or a polymer dispersant.

Table 7 also shows that tanks containing an anodic inhibitor (tartaric acid), i.e., inventive corrosion inhibiting compositions 3A and 3B, and comparative corrosion inhibiting composition 3D were significantly less turbid than tanks not containing the anodic inhibitor (tartaric acid). Thus, in addition to the anodic inhibitor being beneficial to the corrosion inhibition properties, the anodic inhibitor can also provide a less turbid cooling water.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A water treatment composition comprising:
(a) a cathodic inhibitor comprising at least one rare earth metal;
(b) an anodic inhibitor comprising at least one polycarboxylic acid; and
(c) a polymer dispersant comprising at least one sulfonic group.

2. The water treatment composition of claim 1, wherein the polycarboxylic acid comprises a hydroxy polycarboxylic acid.

3. The water treatment composition of claim 1, wherein the rare earth metal comprises lanthanum, cerium, or yttrium.

4. The water treatment composition of claim 1, wherein the polycarboxylic acid is tartaric acid, citric acid, malic acid, ascorbic acid, glucaric acid, coumaric acid, propionic acid, oxobutyric acid, 2,3-pyridinedicaroboxylic acid, 4,5-imidazoledicarboxylic acid, 1,2,3,4-butanetetracarboxylic acid (BTCA), polyepoxysuccinic acid (PESA), salts thereof, or a combination thereof.

5. The water treatment composition of claim 1, wherein the polycarboxylic acid polycarboxylic acid comprises tartaric acid or a salt thereof.

6. The water treatment composition of claim 1, wherein the polymer dispersant comprises at least one monomeric component selected from acrylamidomethanesulfonic acid, (dimethyl(2-oxobut-3-en-1-yl)ammonio)methanesulfonate, allyloxypolethoxy(10) sulfonic acid, 2-acrylamido-2-methylpropane sulfonic acid, 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and combinations thereof.

7. The water treatment composition of claim 1, wherein the water treatment composition further comprises silica or a silicate.

8. The water treatment composition of claim 1, wherein the water treatment composition further comprises at least one scale inhibitor.

9. The water treatment composition of claim 1, wherein the water treatment composition further comprises at least one azole-based corrosion inhibitor.

10. A method of inhibiting corrosion of a metal in an industrial water system, the method comprising:
treating water of the industrial water system with a corrosion inhibiting-effective amount of:
(a) a cathodic inhibitor comprising at least one rare earth metal;
(b) an anodic inhibitor comprising at least one polycarboxylic acid; and
(c) a polymer dispersant comprising at least one sulfonic group,
to provide a treated water.

11. The method of claim 10, wherein the polycarboxylic acid is a hydroxy polycarboxylic acid.

12. The method of claim 10, wherein the rare earth metal comprises lanthanum, cerium, or yttrium.

13. The method of claim 10, wherein the polycarboxylic acid comprises tartaric acid, citric acid, malic acid, ascorbic acid, glucaric acid, coumaric acid, propionic acid, oxobutyric acid, 2,3-pyridinedicaroboxylic acid, 4,5-imidazoledicarboxylic acid, 1,2,3,4-butanetetracarboxylic acid (BTCA), polyepoxysuccinic acid (PESA), salts thereof, or a combination thereof.

14. The method of claim 10, wherein the polycarboxylic acid comprises tartaric acid or a salt thereof.

15. The method of claim 10, wherein the polymer dispersant comprises at least one monomeric component selected from acrylamidomethanesulfonic acid, (dimethyl(2-oxobut-3-en-1-yl)ammonio)methanesulfonate, allyloxypolethoxy(10) sulfonic acid, 2-acrylamido-2-methylpropane sulfonic acid, 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and combinations thereof.

16. The method of claim 10, wherein the method further comprises treating the water with silica or a silicate.

17. The method of claim 10, wherein the method further comprises treating the water with a scale inhibitor.

18. The method of claim 10, wherein the method further comprises treating the water with an azole-based corrosion inhibitor.

19. The method of claim 10, wherein the industrial water system comprises a cooling water system.

20. The method of claim 10, wherein the metal comprises stainless steel, alloy steel, galvanized steel, tool steel, mild steel, aluminum, brass, bronze, iron, or copper.
